(19) United States
(12) Patent Application Publication
(10) Pub. No.: US 2026/0291163 A1
(43) Pub. Date: Sep. 24, 2026

(54) METHOD FOR GENERATION OF COLLIMATED ATTOSECOND GAMMA-RAY RADIATION AND ELECTRON-POSITRON PAIR

(71) Applicant: The Extreme Light Infrastructure ERIC, Prague (CZ)

(72) Inventors: Prokopis Hadjisolomou, Praha (CZ); Tae Moon Jeong, Praha (CZ); Sergey Vladimirovich Bulanov, Praha (CZ)

(21) Appl. No.: 19/087,606

(22) Filed: Mar. 24, 2025

(51) Int. Cl. H01S 4/00; G21K 1/02; G21K 1/16

(52) U.S. Cl. CPC H01S 4/00; G21K 1/02; G21K 1/16

(57) ABSTRACT

The present disclosure relates to methods for generating collimated attosecond gamma-ray radiation and electron-positron pair production using high-intensity laser interactions with a wire target. The method includes directing a radially polarized laser beam (1) onto a cylindrical wire target (2) with a radius of λ and a length from 2λ to 10λ, where λ is the laser wavelength. The laser pulse penetrates the target, ejecting electron bunches (3) with a longitudinal momentum at least two orders of magnitude higher than their transverse momentum. These electron bunches (3) are further accelerated by the radially polarized laser beam (1) and then collide with a counter-propagating linearly polarized laser beam (4).

### BACKGROUND OF THE INVENTION

### Field of the Invention

The present invention relates to high-energy particle generation and gamma-ray emission using ultra-intense laser-matter interactions. More specifically, the invention pertains to a tunable particle generation scheme that utilizes the interaction of high-power lasers with a thin wire target to produce highly collimated, ultrabright gamma-photons and dense electron-positron pairs. The invention finds applications in fields such as astrophysics, radiotherapy, nuclear physics, materials science, and high-energy physics.

### Description of the Related Art

High-energy gamma-ray bursts (GRBs) are among the most energetic events observed in astrophysics, reaching luminosities of up to 10⁵⁴ erg within a few seconds. These bursts are thought to originate from relativistic jets of lepton-hadron plasma resulting from stellar collisions, black hole formation, and subsequent plasma instabilities. The exact mechanisms underlying GRB generation remain a subject of intense research, with strong electromagnetic fields playing a crucial role in accelerating high-energy electrons, which then emit gamma-photons through synchrotron self-Compton radiation.

In laboratory settings, the interaction of multi-petawatt lasers with plasma has been demonstrated as a means of generating high-energy gamma-ray flashes. This process involves the acceleration of electrons by an intense electromagnetic field, followed by the emission of gamma-photons. Additionally, gamma-ray generation in laser-plasma interactions is accompanied by the creation of electron-positron pair plasma, analogous to astrophysical phenomena observed in GRBs.

High-energy photon and electron/positron beams have broad applications in modern science, including radiotherapy, photonuclear fission, neutron sources, materials science, nuclear physics, and fundamental physics studies. However, current methods for generating high-energy particle beams typically rely on large-scale facilities such as radio-frequency accelerators, which limit their accessibility and practical applications. Consequently, there is growing interest in alternative methods for producing high-energy particles using compact, high-intensity laser systems.

The invention of chirped pulse amplification technology has enabled the development of petawatt-class laser systems, which have become attractive tools for particle acceleration and radiation generation. Multi-petawatt laser facilities, such as ELI-Beamlines, expected laser intensities exceeding 10²³ W/cm², with ongoing developments toward 100 PW laser systems. These advancements provide new opportunities for studying high-energy particle generation in ultra-intense laser-plasma interactions.

When ultra-intense lasers (~10²² W/cm²) interact with matter, they produce energetic ions, electrons, positrons, and gamma-photons. Conventional laser-driven particle acceleration schemes have demonstrated efficient conversion of laser energy into particle energy, but they often suffer from large beam divergences, reducing the brightness of the emitted gamma-rays and particle beams. This limits their effectiveness for applications requiring highly collimated, ultrabright beams.

Therefore, there is a need for an improved method of generating high-energy, highly collimated gamma-photon beam and electron-positron pairs using ultra-intense laser interactions with matter. The present invention addresses this need.

### BRIEF SUMMARY OF THE INVENTION

The present invention provides a method for generating collimated attosecond gamma-ray radiation. The method comprises generating a radially polarized laser pulse capable of ejecting electrons by a laser-matter interaction. The radially polarized laser pulse is focused by a parabolic mirror having a ratio of focal length to laser beam diameter of at least 4. A wire target with a cylindrical body having a radius of λ and a length of from 2λ up to 10λ, wherein λ is the laser wavelength, is irradiated with the focused radially polarized laser pulse. The radially polarized laser pulse penetrates the wire target, followed by ejecting the electron bunches. The ejected electron bunches are accelerated by the radially polarized laser pulse, wherein the longitudinal momentum of the ejected electron bunches is at least two orders of magnitude higher than the transverse momentum. A linearly polarized laser pulse collides with the accelerated electron bunches, wherein the electron bunches and the linearly polarized laser pulse are counter-propagating. A gamma-ray flash is generated by focusing the linearly polarized laser pulse to a focal spot having a diameter from 5λ up to 25λ at FWHM.

The present invention also provides a method for generating electron-positron pairs. The method comprises generating a radially polarized laser pulse capable of ejecting electrons by a laser-matter interaction. The radially polarized laser pulse is focused by a parabolic mirror having a ratio of focal length to laser beam diameter of at least 2. A wire target with a cylindrical body having a radius of A and a length from 2λ up to 10λ, wherein λ is the laser wavelength, is irradiated with the focused radially polarized laser pulse. The radially polarized laser pulse penetrates the wire target, followed by ejecting the electron bunches. The ejected electron bunches are accelerated by the radially polarized laser pulse, wherein the longitudinal momentum of the ejected electron bunches is at least two orders of magnitude higher than the transverse momentum. A linearly polarized laser pulse collides with the accelerated electron bunches, wherein the electron bunches and the linearly polarized laser pulse are counter-propagating. A gamma-ray flash is generated by focusing the linearly polarized laser pulse to a focal spot having a diameter from λ up to 5λ at FWHM.

### BRIEF DESCRIPTION OF THE SEVERAL VIEWS OF THE DRAWINGS

FIG. 1 illustrates the interaction stages of the method according to the present invention: (a) represents an injection stage, wherein an f/4-radially polarized laser interacts with a lithium wire target, resulting in axial electron emission. (b) represents a boosting stage, wherein the emitted electrons are accelerated up to the GeV energy level. (c) represents a collision stage, wherein the emitted electrons collide with a counter-propagating linearly polarized laser. The laser-electron interaction results in a highly directional gamma-ray flash accompanied by dense electron-positron pair generation.

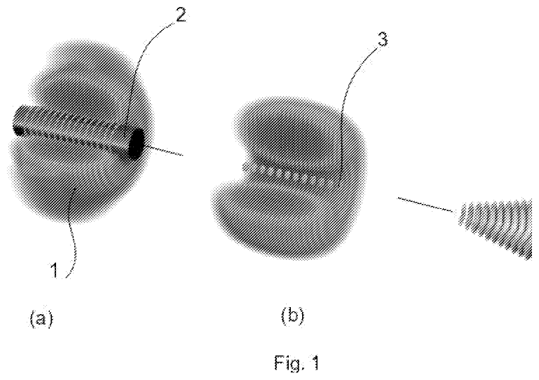

### DETAILED DESCRIPTION OF THE INVENTION

For purposes of the present invention, the term “collimated attosecond gamma-ray radiation” refers to a beam of photons having an energy in the GeV range, emitted in a spatially confined manner with a divergence, depending on the emitted photon energy interval and laser configurations. The radiation is emitted in a series of attosecond-duration pulses, wherein the most intense pulses have a duration of attoseconds at full-width at half-maximum (FWHM).

For purposes of the present invention, the term “radially polarized laser pulse capable of ejecting electrons by a laser plasma-matter interaction” refers to a high-intensity laser pulse with radial polarization that interacts with a solid target to initiate electron ejection. The laser-matter interaction is achieved by focusing the radially polarized laser pulse onto a wire target, wherein the target has a cylindrical body with a radius of λ and a length from 2λ up to 10λ. The laser field penetrates the wire target, leading to localized ionization and strong electron acceleration. The interaction results in the emission of electron bunches, which are subsequently accelerated by the radially polarized laser field. The target material is selected to allow deep laser penetration and facilitate efficient electron ejection, ensuring high charge electron bunches with minimal transverse momentum dispersion.

For purposes of the present invention, the term “parabolic mirror” refers to a mirror having a cross-section in the shape of a parabola, forming a three-dimensional paraboloid that enables the efficient focusing of light. The parabolic mirror used in accordance with the present invention is configured to focus a radially polarized laser pulse with a focal length-to-beam diameter ratio (f-number) of at least 4 (f/4λ for gamma-photon beams or at least 2 (f/2) for electron-positron pair production, respectively. The mirror may include metallic or dielectric coatings to enhance reflectivity and minimize losses, particularly for high-intensity laser applications. The parabolic mirror is designed to form a tight beam focus in the laser plasma interaction region, ensuring effective interaction with the wire target for the ejection and acceleration of electron bunches.

For purposes of the present invention, the term “wire target with a cylindrical body having a radius of λ and a length of from 2λ up to 10λ, wherein λ is the laser wavelength” refers to a solid target in the form of a cylindrical wire structure. The wire target is designed to interact with a radially polarized laser pulse focused by a parabolic mirror, enabling efficient electron ejection and acceleration. The wire target has a radius of λ, which ensures optimal penetration of the laser field while maintaining a balance between electron density and acceleration efficiency. The length of the wire target is selected within a range of 2λ to 10λ to optimize electron ejection and prevent excessive energy loss due to Coulomb forces. The wire target is composed of a material with a sufficient electron number density, which facilitates strong ionization and supports high-charge electron bunch generation. The wire target geometry is distinct from hollow cylindrical or conical targets and allows for the efficient emission of attosecond electron bunches and gamma-photon generation while mitigating the limitations associated with flat-foil targets and excessive electron pile-up at the laser interaction front.

For purposes of the present invention, the term “focal spot having a diameter from 5λ up to 25λ at FWHM” for attosecond gamma-ray radiation, resp. focal spot having a diameter from λ up to 5λ at FWHM” for electron-positron pair production refers to the full-width at half-maximum (FWHM) diameter of the focused laser beam, which determines the interaction dynamics between the laser pulse and the target. By ensuring a focal spot diameter of from 5λ up to 25λ at FWHM for attosecond gamma-ray radiation, resp. focal spot having a diameter from λ up to 5λ at FWHM for electron-positron pair production, the laser maintains an optimal balance. This condition supports the controlled generation of gamma-ray flashes and electron-positron pairs, ensuring high-yield, high-energy photon emission and particle production.

The present invention is directed to a method for generating collimated attosecond gamma-ray radiation. A radially polarized laser beam 1 is focused using a parabolic mirror onto a wire target 2, which results in electron ejection and acceleration. The ejected electrons 3 are further boosted by the laser field before colliding with a counter-propagating linearly polarized laser beam 4, which results in gamma-ray flash emission and electron-positron pair generation. At the injection stage, a radially polarized laser beam 1 focused by a parabolic mirror with an f-number of at least 4 interacts with a wire target 2. The wire target 2 is a cylindrical structure with a radius of λ and a length ranging from 2λ to 10λ, where λ is the laser wavelength. The laser field fully penetrates the wire target 2, leading to the ejection of electron 3 bunches. These ejected electron 3 bunches are then accelerated, achieving a longitudinal momentum that is at least two orders of magnitude higher than the transverse momentum. The interaction culminates in a collision with a linearly polarized counter-propagating laser beam 4, which, when focused to a spot size of from 5λ up to 25λ at FWHM. In some embodiment, the spot size can be 1 μm from the laser beam has wavelength 0.8 μm. This results in the emission of a collimated attosecond gamma-ray flash. The process efficiently generates high-energy photon emission, suitable for applications requiring intense, collimated gamma-ray radiation.

At the injection stage, a radially polarized laser beam 1 is focused by a parabolic mirror with an f-number of at least 4 and directed onto a wire target 2. In a preferred embodiment, the lithium target is selected due to its low electron number density, which facilitates deep penetration of the laser field into the target volume. The electron number density of the lithium wire target 2 is approximately 1.39×10²⁹ m⁻³, ensuring efficient interaction with the radially polarized laser beam 1.

The radially polarized laser beam 1 focuses into a ring-like intensity distribution, allowing uniform interaction across the wire target 2. The laser pulse penetrates the wire target 2, resulting in the ejection of high-density electron 3 bunches. These electron 3 bunches exhibit a cut-off energy of approximately 0.6 GeV and detach from the bulk target, moving in the direction of laser propagation. The longitudinal (x-direction) electric field component in the center of the radially polarized laser beam 1 remains finite, while the magnetic field is negligible, ensuring stable acceleration of the emitted electrons 3.

During the boosting stage, the electron 3 bunches are further accelerated by the radially polarized laser beam 1, with their energy distribution peaking at approximately 0.2±0.1 GeV and extending up to 2.2 GeV. The electron acceleration dynamics are optimized due to the unique electric field structure of the radially polarized laser beam 1, leading to minimal transverse momentum dispersion. This stage ensures that the electron 3 bunches achieve the necessary energy levels for efficient gamma-ray generation.

At the collision stage, a linearly polarized counter-propagating laser beam 4 with a peak power of approximately 25 PW and a pulse duration of 25 fs is introduced. The linearly polarized laser beam 4 has a wavelength of 0.8 μm and is focused to a spot size ranging from 0.8 μm to 20 μm at FWHM from the laser having wavelength 0.8 μm. The laser peak intensity varies between approximately 7×10²¹ Wcm⁻² and 4.4×10²⁴ Wcm⁻², ensuring tunable interaction conditions with the accelerated electron 3 bunches. The collision of the counter-propagating linearly polarized laser beam 4 with the electron 3 bunches results in the emission of a highly collimated gamma-ray flash. The brilliance of the generated gamma-ray source is optimized by adjusting the focusing conditions of the linearly polarized laser beam 4, achieving an ultra-bright source with a radiance of approximately 5.27×10¹⁵ PWsr⁻¹m⁻².

The produced gamma-ray source is characterized by an extremely high brightness in the multi-MeV range, reaching approximately 9×10²⁵ s⁻¹ mm⁻² per 0.1% BW. The total number of emitted gamma photons with energy above 1 MeV is approximately 9.6×10¹¹, making this method highly effective for generating high-intensity collimated gamma-ray flashes. The radiance of the generated gamma-ray source approaches that of astrophysical gamma-ray bursts, providing a compact, laser-driven alternative for high-energy photon applications.

In another embodiment, the method utilizes a radially polarized laser beam 1 with a peak power of at least 25 PW. The wire target 2 is a lithium-based micro-wire with a cylindrical body of radius λ and a length ranging from 2λ to 10λ. The linearly polarized laser beam 4 is focused by a parabolic mirror with an f-number of at least 4 and interacts with the wire target 2, resulting in deep penetration and ejection of high-density electron 3 bunches. In some embodiment, the linearly polarized laser beam 4 can have peak power below 1 PW for gamma-ray production.

In this embodiment, the radially polarized laser beam 1 is configured to have a wavelength of 0.8 μm and a pulse length between 10 fs and 150 fs. The focal spot size of the linearly polarized counter-propagating laser beam 4 is between 1 μm and 20 μm at FWHM. The interaction of the radially polarized laser beam 1 with the wire target 2 produces electron 3 bunches with a cut-off energy exceeding 0.6 GeV, which are subsequently accelerated to an energy distribution peak of approximately 0.2±0.1 GeV, extending up to 2.2 GeV.

During the final collision stage, the linearly polarized counter-propagating laser beam 4 has a peak intensity in the range of 7×10²¹ Wcm⁻² up to 4.4×10²⁴ Wcm⁻². The interaction between the electron 3 bunches and the linearly polarized laser beam 4 results in an optimized gamma-ray flash, with photon emission rates reaching approximately 9×10²⁵ s⁻¹ mm⁻² per 0.1% BW. The optimized focusing of the laser beam 4 ensures high collimation and brightness of the emitted gamma-ray radiation.

In a further embodiment, the radially polarized laser beam 1 is configured to have flat wavefronts at the focal spot, ensuring low divergence. The wire target 2 used in this embodiment has a fixed length of 4λ and a cylindrical body with a radius of λ. The radially polarized laser beam 1 is focused by a parabolic mirror with an f-number of at least 4 and interacts with the wire target 2, leading to uniform penetration and ejection of electron 3 bunches.

The radially polarized laser beam 1 has a peak power of 25 PW and a wavelength of 0.8 μm. The linearly polarized counter-propagating laser beam 4 is focused to a spot size of at least 20 μm at FWHM. The interaction results in electron acceleration with a peak energy distribution of 0.2+0.1 GeV, extending up to 2.2 GeV.

The optimized configuration ensures an efficient gamma-ray flash with photon emission rates exceeding 9×10²⁵ s⁻¹ mm⁻² per 0.1% BW. The total number of emitted gamma photons with energy above 1 MeV exceeds 9.6×10¹¹, making this method suitable for applications requiring high-brightness collimated gamma-ray sources.

In another embodiment, the method is configured to generate electron-positron pairs through laser-plasma interaction. A radially polarized laser beam 1 is focused by a parabolic mirror with an f-number of at least 2 and directed onto a wire target 2. The wire target 2 is a cylindrical structure with a radius of λ and a length ranging from 2λ to 10λ, ensuring optimal laser-matter interaction.

Upon irradiation by the radially polarized laser beam 1, the wire target 2 is penetrated, leading to the ejection of high-density electron 3 bunches. These electron 3 bunches achieve a longitudinal momentum at least two orders of magnitude higher than their transverse momentum, ensuring efficient acceleration.

A linearly polarized counter-propagating laser beam 4 is then introduced, focused to a spot size within 1λ-5λ at FWHM. The interaction of the accelerated electron 3 bunches with the linearly polarized laser beam 4 results in the emission of high-energy gamma-ray photons. The subsequent interaction of these gamma-ray photons with the laser field facilitates prolific electron-positron pair production.

This method enables efficient generation of dense electron-positron plasmas, making it suitable for studies in high-energy physics and astrophysics applications requiring intense gamma-ray flashes and relativistic pair plasmas.

In another embodiment, the method is configured to generate electron-positron pairs through laser-plasma interaction. A radially polarized laser beam 1 is focused by a parabolic mirror with an f-number of at least 2 and directed onto a lithium wire target 2. The wire target 2 is a cylindrical structure with a radius of λ and a length of 4λ, ensuring optimal laser-matter interaction.

Upon irradiation by the radially polarized laser beam 1, the wire target 2 is penetrated, leading to the ejection of high-density electron 3 bunches. These electron 3 bunches achieve a longitudinal momentum at least two orders of magnitude higher than their transverse momentum, ensuring efficient acceleration.

A linearly polarized counter-propagating laser beam 4 is then introduced, focused to a spot size within 1λ-5λ at FWHM. The interaction of the accelerated electron 3 bunches with the linearly polarized laser beam 4 results in the emission of high-energy gamma-ray photons. The subsequent interaction of these gamma-ray photons with the laser field facilitates prolific electron-positron pair production.

In a variation of this embodiment, the radially polarized laser beam 1 has a peak power of 25 PW and a pulse duration ranging from 10 fs to 150 fs. The beam is configured with a wavelength of 0.8 μm and exhibits flat wavefronts at the focal spot, ensuring optimized acceleration. The linearly polarized laser beam 4 intensity is within the range of 7×10²¹ up to 4.4×10²⁴ W cm⁻². In some embodiment, the linearly polarized laser beam 4 can have peak power at least 10 PW for electron-positron pair production, preferably above 25 PW. The enhanced configuration results in a significant increase in gamma-ray production and positron yield, making it suitable for high-energy physics experiments and astrophysical studies requiring relativistic pair plasmas.

1. A method for generating collimated attosecond gamma-ray radiation comprising:
a) generating a radially polarized laser pulses capable of ejecting electron by a laser-matter interaction;
b) focusing the radially polarized laser pulse by a parabolic mirror having ratio of focal length to laser beam diameter at least 4;
c) irradiating a wire target with the focused radially polarized laser pulse; wherein the wire target has a cylindrical body having radius of λ and a length from 2λ up to 10λ, wherein λ is the laser wavelength;
d) penetrating the wire target by the radially polarized laser followed by ejecting the electron bunches; and
e) accelerating the ejected electron bunches by the radially polarized laser pulse, wherein the longitudinal momentum of the ejected electron bunches is at least two orders of magnitude higher than the transverse momentum;
f) colliding a linearly polarized laser pulse with the accelerated electron bunches, wherein electron bunches and the linearly polarized laser pulse are counter-propagating;
g) generating gamma-ray flash by focusing the linearly polarized laser pulse to a focal spot having diameter from 5λ up to 25λ at FWHM.

2. The method of claim 1, wherein the step irradiating the wire target is irradiating lithium wire target.

3. The method of claim 1, wherein the linearly polarized laser pulse has peak power at least 1 PW.

4. The method of claim 1, wherein the radially polarized laser pulse has peak power 25 PW and length of the pulse is from 10 fs to 150 fs.

5. The method of claim 1, wherein the radially polarized laser pulses are having wavelength 0.8 μm.

6. The method of claim 5, wherein the focal spot is from 0.8 μm to 20 μm.

7. The method of claim 1, wherein the linearly polarized laser pulses are having peak intensity in the range from 7×10²¹ up to 4.4×10²⁴ W cm⁻².

8. The method of claim 1, wherein the radially polarized laser pulses are having flat wavefronts at the focal spot.

9. The method of claim 1, wherein the length of the wire target is 4).

10. A method for generating electron positron pair, the method comprising:
generating a radially polarized laser pulses capable of ejecting electron by a laser-matter interaction;
focusing the radially polarized laser pulse by a parabolic mirror having ratio of focal length to laser beam diameter at least 2;
irradiating a wire target with the focused radially polarized laser pulse; wherein the wire target has a cylindrical body having radius of λ and a length from 2λ up to 10λ, where λ is the laser wavelength;
penetrating the wire target by the radially polarized laser followed by ejecting the electron bunches; and
accelerating the ejected electron bunches by the radially polarized laser pulse, wherein the longitudinal momentum of the ejected electron bunches is at least two orders of magnitude higher than the transverse momentum;
colliding a linearly polarized laser pulse with the accelerated electron bunches, wherein electron bunches and the linearly polarized laser pulse are counter-propagating;
generating gamma-ray flash by focusing the linearly polarized laser pulse to a focal spot having diameter from λ up to 5λ at FWHM.

11. The method of claim 10, wherein the step irradiating the wire target is irradiating lithium wire target.

12. The method of claim 10, wherein the linearly polarized laser pulse has peak power at least 10 PW.

13. The method of claim 12, wherein the linearly polarized laser pulse has peak power at least 25 PW.

14. The method of claim 10, wherein the radially polarized laser pulse has peak power 25 PW and length of the pulse is from 10 fs to 150 fs.

15. The method of claim 10, wherein the radially polarized laser pulses are having wavelength 0.8 μm.

16. The method of claim 15, wherein the focal spot is from 0.8 μm up to 4 μm.

17. The method of claim 10, wherein the linearly polarized laser pulses are having peak intensity in the range from 7×10²¹ up to 4.4×10²⁴ W cm⁻².

18. The method of claim 10, wherein the radially polarized laser pulses are having flat wavefronts at the focal spot.

19. The method of claim 10, wherein the length of the wire target is 4λ.
